(19) United States
(12) Patent Application Publication
(10) Pub. No.: US 2021/0235044 A1
(43) Pub. Date: Jul. 29, 2021

(54) IMAGE PROCESSING DEVICE, CAMERA DEVICE, MOBILE BODY, IMAGE PROCESSING METHOD, AND PROGRAM

(71) Applicant: SZ DJI TECHNOLOGY CO., LTD., Shenzhen (CN)

(72) Inventors: Kunihiko IETOMI, Tokyo (JP); Bin CHEN, Shenzhen (CN)

(21) Appl. No.: 17/229,851

(22) Filed: Apr. 13, 2021

Related U.S. Application Data
(63) Continuation of application No. PCT/CN2019/113698, filed on Oct. 28, 2019.

(30) Foreign Application Priority Data
Oct. 29, 2018 (JP) 2018-202749

(51) Int. Cl. H04N 7/18; H04N 5/225; H04N 9/09; H04N 5/232

(52) U.S. Cl. CPC H04N 7/185; H04N 5/23229; H04N 9/09; H04N 5/2258

(57) ABSTRACT

An image processing device includes a processor and a storage device. The storage device stores a program that, when executed by the processor, causes the processor to select a first image signal in a first period, select the first image signal and a second image signal in a second period, generate image data for display based on the first image signal selected in the first period, and generate image data for recordation according to a predetermined recording format based on the first image signal and the second image signal selected in the second period. The first image signal has a first wavelength band and is output by a first image sensor of a camera device. The second image signal has a second wavelength band and is output by a second image sensor of the camera device.

### CROSS-REFERENCE TO RELATED APPLICATIONS

This application is a continuation of International Application No. PCT/CN2019/113698, filed Oct. 28, 2019, which claims priority to Japanese Application No. 2018-202749, filed Oct. 29, 2018, the entire contents of both of which are incorporated herein by reference.

### TECHNICAL FIELD

The present disclosure relates to an image processing device, a camera device, a mobile body, an image processing method, and a program.

### BACKGROUND

U.S. Patent Application Publication No. 2017/356799 discloses an unmanned aerial vehicle (UAV), which carries a multi-band sensor.

### SUMMARY

Embodiments of the present disclosure provide an image processing device including a processor and a storage device. The storage device stores a program that, when executed by the processor, causes the processor to select a first image signal in a first period, select the first image signal and a second image signal in a second period, generate image data for display based on the first image signal selected in the first period, and generate image data for recordation according to a predetermined recording format based on the first image signal and the second image signal selected in the second period. The first image signal has a first wavelength band and is output by a first image sensor of a camera device. The second image signal has a second wavelength band and is output by a second image sensor of the camera device.

Embodiments of the present disclosure provide a mobile body including a camera device. The camera device includes a first image sensor, a second image sensor, and an image processing device. The image processing device includes processor and a storage device. The storage device stores a program that, when executed by the processor, causes the processor to select a first image signal in a first period, select the first image signal and a second image signal in a second period, generate image data for display based on the first image signal selected in the first period, and generate image data for recordation according to a predetermined recording format based on the first image signal and the second image signal selected in the second period. The first image signal has a first wavelength band and is output by a first image sensor of a camera device. The second image signal has a second wavelength band and is output by a second image sensor of the camera device.

Embodiments of the present disclosure provide an image processing method. The image processing method includes selecting a first image signal in a first period, selecting the first image signal and a second image signal in a second period, generating image data for display based on the first image signal selected in the first period, and generating image data for recordation according to a predetermined recording format based on the first image signal and the second image signal selected in the second period. The first image signal has a first wavelength band and is output by a first image sensor of a camera device. The second image signal has a second wavelength band and is output by a second image sensor of the camera device.

### BRIEF DESCRIPTION OF THE DRAWINGS

FIG. 1 is a schematic diagram showing appearances of an unmanned aerial vehicle (UAV) and a remote operation device according to some embodiments of the present disclosure.

FIG. 2 is a schematic diagram showing an appearance of a camera device carried by the UAV according to some embodiments of the present disclosure.

FIG. 3 is a schematic diagram showing functional modules of the UAV according to some embodiments of the present disclosure.

FIG. 4 is a schematic diagram showing functional modules of the camera device according to some embodiments of the present disclosure.

FIG. 5 is a schematic diagram showing a scene of photographing using the UAV, which carries the camera device according to some embodiments of the present disclosure.

FIG. 6 is a schematic diagram showing recording locations of multispectral images on a flight route according to some embodiments of the present disclosure.

FIG. 7 is a schematic diagram showing recording locations of multispectral images on a flight route according to some embodiments of the present disclosure.

FIG. 8 is a schematic diagram showing an image of a time flow of processing contents in a camera controller according to some embodiments of the present disclosure.

FIG. 9 is a schematic flowchart of a processing process of the camera device recording the multispectral image according to some embodiments of the present disclosure.

FIG. 10 is a schematic flowchart of a processing process of the camera device recording the multispectral image according to some embodiments of the present disclosure.

FIG. 11 is a schematic flowchart of a processing process of the camera device recording the multispectral image according to some embodiments of the present disclosure.

FIG. 12 is a schematic flowchart of a processing process of the camera device recording the multispectral image according to some embodiments of the present disclosure.

FIG. 13 is a schematic diagram showing an appearance of a camera device that is carried by the UAV according to some embodiments of the present disclosure.

FIG. 14 is a schematic diagram of a hardware configuration according to some embodiments of the present disclosure.

### REFERENCE NUMERALS

10 UAV
20 UAV body
30 UAV controller
32 Storage device
36 Communication interface
40 Propeller
41 Global positioning system (GPS) receiver
42 Inertia measurement unit (IMU)
43 Magnetic compass
44 Barometric altimeter
45 Temperature sensor
46 Humidity sensor
50 Gimbal
60 Camera Device
100 Camera Device
110 R camera
112 R image sensor
114 Optical system
120 G camera
122 G image sensor
124 Optical system
130 B camera
132 B image sensor
134 Optical system
140 RE camera
142 RE image sensor
144 Optical system
150 NIR camera
152 NIR image sensor
154 Optical system
160 RGB camera
170 Multiplexer
172 Input receiver
174 Demosaicing processor
178 Record processor
180 Camera controller
184 Receiver
188 Switcher
190 Transmitter
192 Storage device
1200 Computer
1210 Host controller
1212 Central processing unit (CPU)
1214 Random-access memory (RAM)
1220 I/O controller
1222 Communication interface
1230 Read-only memory (ROM)

### DETAILED DESCRIPTION OF THE EMBODIMENTS

The present disclosure is described through embodiments, but following embodiments do not limit the present disclosure. Not all the feature combinations described in embodiments of the present disclosure are necessary for the solutions of the present disclosure. Those of ordinary skill in the art can make various modifications or improvements to following embodiments. Such modifications or improvements are within the scope of the present disclosure according to the description of the claims.

Various embodiments of the present disclosure are described with reference to flowcharts or block diagrams. In this disclosure, a block in the figures can represent (1) an execution stage of a process of operation or (2) a functional unit of a device for operation execution. The stage or unit can be implemented by a programmable circuit and/or a processor. A special-purpose circuit may include a digital and/or analog hardware circuit or may include an integrated circuit (IC) and/or a discrete circuit. The programmable circuit may include a reconfigurable hardware circuit. The reconfigurable hardware circuit may include logical AND, logical OR, logical XOR, logical NAND, logical NOR, another logical operation circuit, a trigger, a register, a field-programmable gate arrays (FPGA), a programmable logic array (PLA), or another storage device.

A computer-readable medium may include any tangible device that can store commands executable by an appropriate device. The commands, stored in the computer-readable medium, can be executed to perform operations consistent with the disclosure, such as those specified according to the flowchart or the block diagram described below. The computer-readable medium may include an electronic storage medium, a magnetic storage medium, an optical storage medium, an electromagnetic storage medium, a semiconductor storage medium, etc. The computer-readable medium may include a floppy disk®, hard drive, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disc (DVD), Blu-ray (RTM) disc, memory stick, integrated circuit card, etc.

A computer-readable command may include any one of source code or object code described by any combination of one or more programming languages. The source or object codes include traditional procedural programming languages. The traditional procedural programming languages can be assembly commands, command set architecture (ISA) commands, machine commands, machine-related commands, microcode, firmware commands, status setting data, or object-oriented programming languages and “C” programming languages or similar programming languages such as Smalltalk, JAVA (registered trademark), C++, etc. Computer-readable commands can be provided locally or via a wide area network (WAN) such as a local area network (LAN) or the Internet to a general-purpose computer, a special-purpose computer, or a processor or programmable circuit of other programmable data processing device. The processor or the programmable circuit can execute computer-readable commands to be a manner for performing the operations specified in the flowchart or block diagram. The example of the processor includes a computer processor, a processing unit, a microprocessor, a digital signal processor, a controller, a microcontroller, etc.

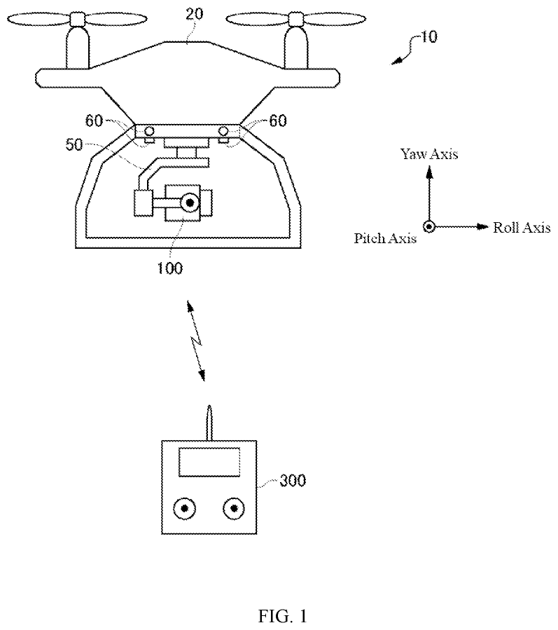

FIG. 1 is a schematic diagram showing appearances of an unmanned aerial vehicle (UAV) 10 and a remote operation device 300 according to some embodiments of the present disclosure. The UAV 10 includes a UAV body 20, a gimbal 50, a plurality of cameras 60, and a camera device 100. The gimbal 50 and the camera device 100 are an example of a camera system. The UAV 10 is an example of a mobile body. The mobile body can include an aerial body such as an airplane capable of moving in the air, a vehicle capable of moving on the ground, a ship capable of moving on the water, etc. The aerial body moving in the air not only includes the UAV 10 but also includes another aircraft, airship, helicopter, etc., capable of moving in the air.

The UAV body 20 includes a plurality of rotors. The plurality of rotors are an example of the propeller. The UAV body 20 controls rotations of the plurality of rotors to cause the UAV 10 to fly. The UAV body 20 uses, for example, four rotors to cause the UAV 10 to fly. A number of the rotors is not limited to four. In some embodiments, the UAV 10 may also be a fixed-wing aircraft without a rotor.

The camera device 100 is an imaging camera that captures images of an object within a desired imaging range. The gimbal 50 can rotatably support the camera device 100. The gimbal 50 is an example of a support mechanism. For example, the gimbal 50 may support the camera device 100, such that the camera device 100 may use an actuator to rotate about a pitch axis. The gimbal 50 may support the camera device 100, such that the camera device 100 may further use an actuator to rotate by using a roll axis and a yaw axis as rotation axes. The gimbal 50 can rotate the camera device 100 around at least one of the yaw axis, the pitch axis, or the roll axis to change an attitude of the camera device 100.

The plurality of camera devices 60 are sensing cameras that sense surroundings to control flight of the UAV 10. Two of the camera devices 60 may be arranged at a nose, i.e., the front, of the UAV 10. Other two of the camera devices 60 may be arranged at the bottom of the UAV 10. The two camera devices 60 at the front can be used in pair, which function as a stereo camera. The two camera devices 60 at the bottom may also be used in pair, which function as a stereo camera. The camera 60 may detect an existence of an object within the imaging range of the camera 60 and measure a distance to the object. The camera 60 is an example of a measurement device that is configured to measure the object in an imaging direction of the camera device 100. The measurement device may also include another sensor such as an infrared sensor, ultrasonic sensor, etc., that performs measurement on the object in the imaging direction of the camera device 100. The UAV 10 can generate three-dimensional space data for the surrounding of the UAV 10 based on images captured by the plurality of camera devices 60. A number of the camera devices 60 of the UAV 10 is not limited to four, as long as the UAV 10 includes at least one camera device 60. The UAV 10 may also include at least one camera device 60 at each of the head, tail, each side, bottom, and top. An angle of view that can be set in the camera device 60 may be larger than an angle of view that can be set in the camera device 100. The camera device 60 may include a single focus lens or a fisheye lens.

The remote operation device 300 communicates with the UAV 10 to control the UAV 10 remotely. The remote operation device 300 may communicate with the UAV 10 wirelessly. The remote operation device 300 transmits to the UAV 10 instruction information indicating various commands related to the movement of the UAV 10 such as ascent, descent, acceleration, deceleration, forward, backward, rotation, etc. The instruction information includes, for example, instruction information to ascend the UAV 10. The instruction information may indicate a desired height for the UAV 10. The UAV 10 moves to a height indicated by the instruction information received from the remote operation device 300. The instruction information may include an ascending command to ascend the UAV 10. The UAV 10 ascend when receiving the ascending command. When the UAV 10 reaches an upper limit in height, even the UAV 10 receives the ascending command, the UAV 10 may be limited from further ascending.

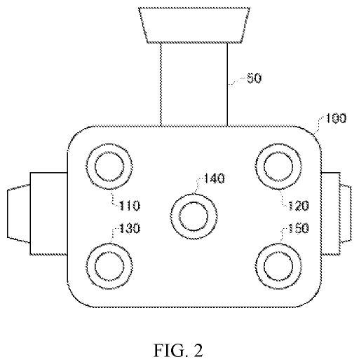

FIG. 2 is a schematic diagram showing an appearance of the camera device 100 carried by the UAV 10 according to some embodiments of the present disclosure. The camera device 100 may be a multispectral camera that is configured to capture each piece of image data in a plurality of predetermined wavelength bandwidths. The camera device 100 includes an R camera 110, a G camera 120, a B camera 130, an RE camera 140, and a NIR camera 150. The camera device 100 may record the images captured by the R camera 110, the G camera 120, the B camera 130, the RE camera 140, and the NIR camera 150 as a multispectral image. The multispectral image, for example, may be used to predict a health status and vitality of crops.

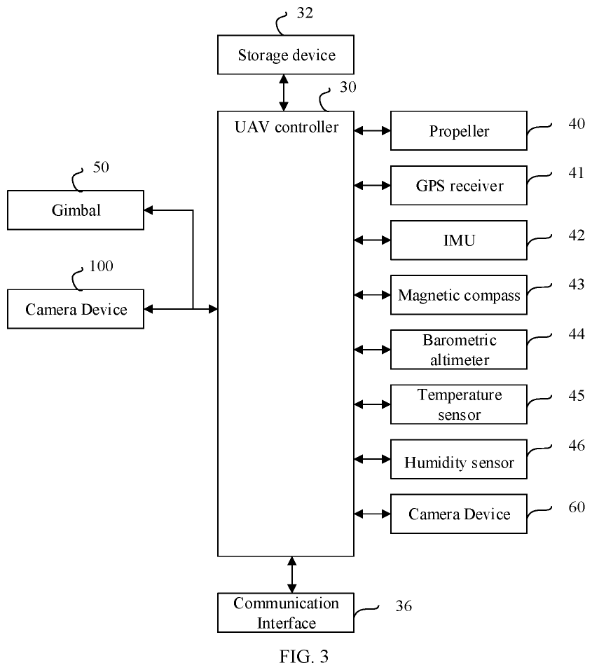

FIG. 3 is a schematic diagram showing functional modules of the UAV 10 according to some embodiments of the present disclosure. The UAV 10 includes a UAV controller 30, a storage device 32, a communication interface 36, a propeller 40, a global positioning system (GPS) receiver 41, an inertia measurement unit (IMU) 42, a magnetic compass 43, a barometric altimeter 44, a temperature sensor 45, a humidity sensor 46, a gimbal 50, a camera device 60, and a camera device 100.

The communication interface 36 may communicate with the remote operation device 300 and other devices. The communication interface 36 may receive instruction information from the remote operation device 300, including various commands for the UAV controller 30. The storage device 32 stores programs needed for the UAV controller 30 to control the propeller 40, the GPS receiver 41, the IMU 42, the magnetic compass 43, the barometric altimeter 44, the temperature sensor 45, the humidity sensor 46, the gimbal 50, the camera devices 60, and the camera device 100. The storage device 32 may be a computer-readable storage medium and may include at least one of SRAM, DRAM, EPROM, EEPROM, or a USB storage drive. The storage device 32 may be detachably arranged inside the UAV body 20.

The UAV controller 30 controls the UAV 10 to fly and photograph according to the programs stored in the storage device 32. The UAV controller 30 may include a microprocessor such as a central processing unit (CPU) or a micro processing unit (MPU), a microcontroller such as a microcontroller unit (MCU), etc. The UAV controller 30 controls the UAV 10 to fly and photograph according to the commands received from the remote operation device 300 through the communication interface 36. The propeller 40 propels the UAV 10. The propeller 40 includes a plurality of rotators and a plurality of drive motors that cause the plurality of rotors to rotate. The propeller 40 causes the plurality of rotors to rotate through the plurality of drive motors to cause the UAV 10 to fly according to the commands from the UAV controller 30.

The GPS receiver 41 receives a plurality of signals indicating time transmitted from a plurality of GPS satellites. The GPS receiver 41 calculates the position (latitude and longitude) of the GPS receiver 41, i.e., the position of the UAV 10 (latitude and longitude), based on the received plurality of signals. The IMU 42 detects an attitude of the UAV 10. The IMU 42 detects accelerations of the UAV 10 in three-axis directions of front and back, left and right, and up and down, and angular velocities in three axis directions of the pitch axis, roll axis, and yaw axis, as the attitude of the UAV 10. The magnetic compass 43 detects an orientation of the head of the UAV 10. The barometric altimeter 44 detects a flight altitude of the UAV 10. The barometric altimeter 44 detects an air pressure around the UAV 10, and converts the detected air pressure into an altitude to detect the altitude. The temperature sensor 45 detects a temperature around the UAV 10. The humidity sensor 46 detects a humidity around the UAV 10.

In the UAV 10 configured as above, the camera device 100 may record the multispectral image data efficiently and confirm captured contents in real-time.

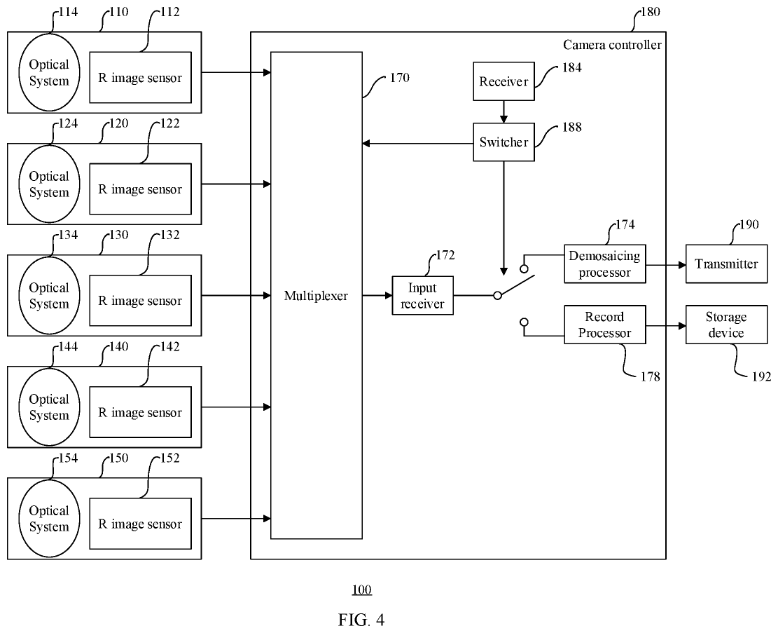

FIG. 4 is a schematic diagram showing functional circuits of the camera device 100 according to some embodiments of the present disclosure. The camera device 100 includes the R camera 110, the G camera 120, the B camera 130, the RE camera 140, and the NIR camera 150. The camera device 100 includes a camera controller 180, a transmitter 190, and a storage device 192. The camera controller 180 includes a multiplexer 170, an input receiver 172, a demosaicing processor 174, and a record processor 178. The camera controller 180 is an example of an image processing device.

The R camera 110 includes an R image sensor 112 and an optical system 114. The R image sensor 112 may be configured to capture an image imaged by the optical system 114. The R image sensor 112 may include a filter that allows light with a wavelength band in a red range to transmit through. An output from the R image sensor 112 may include an R image signal of an image signal of the wavelength band in the red range. The wavelength band in the red range, for example, may range from 620 nm˜750 nm. The wavelength band in the red range may include a specified wavelength band in the red range, for example, 663 nm˜673 nm.

The G camera 120 includes a G image sensor 122 and an optical system 124. The G image sensor 122 may be configured to capture an image imaged by the optical system 124. The G image sensor 122 may include a filter that allows light with a wavelength band in a green range to transmit through. An output from the G image sensor 122 may include a G image signal of an image signal of the wavelength band in the green range. The wavelength band in the green range, for example, may range from 500 nm˜570 nm. The wavelength band in the green range may include a specified wavelength band in the green range, for example, 550 nm˜570 nm.

The B camera 130 includes a B image sensor 132 and an optical system 134. The B image sensor 132 may be configured to capture an image imaged by the optical system 134. The B image sensor 132 may include a filter that allows light with a wavelength band in a blue range to transmit through. An output from the B image sensor 132 may include a B image signal of an image signal of the wavelength band in the blue range. The wavelength band in the blue range, for example, may range from 450 nm˜500 nm. The wavelength band in the blue range may include a specified wavelength band in the blue range, for example, 465 nm˜485 nm.

The RE camera 140 includes an RE image sensor 142 and an optical system 144. The RE image sensor 142 may be configured to capture an image imaged by the optical system 144. The RE image sensor 142 may include a filter that allows light with a wavelength band at an edge of the red range to transmit through. An output from the RE image sensor 142 may include an RE image signal of an image signal of the wavelength band at the edge of the red range. The wavelength band at the edge of the red range, for example, may range from 705 nm˜745 nm. The wavelength band at the edge of the red range may range from 712 nm˜722 nm.

The NIR camera 150 includes a NIR image sensor 152 and an optical system 154. The NIR image sensor 152 may be configured to capture an image imaged by the optical system 154. The NIR image sensor 152 may include a filter that allows light with a wavelength band in a near-infrared range to transmit through. An output from the NIR image sensor 152 may include a NIR image signal of an image signal of the wavelength band in the near-infrared range. The wavelength band in the near-infrared range, for example, may range from 800 nm˜2500 nm. The wavelength band in the near-infrared range may range from 800 nm˜900 nm.

The multiplexer 170 may be configured to receive an image signal output from each of the image sensors. According to a predetermined condition, the multiplexer may be configured to select and input an image signal from any one of the image sensors into the input receiver 172. The multiplexer 170 may be an example of a selector. The multiplexer 170 may select and input the R image signal output from the R camera 110, the G image signal output from the G camera 120, and the B image signal output from the B camera 130 in a first period into the input receiver 172. The multiplexer 170 may discard the RE image signal output from the RE camera 140 and the NIR image signal output from the NIR camera 150.

The multiplexer 170 may select and input the R image signal output from the R camera 110, the G image signal output from the G camera 120, the B image signal output from the B camera 130, the RE image signal output from the RE camera 140, and the NIR image signal output from the NIR camera 150 in a second period, which is different from the first period, into the input receiver 172. The multiplexer 170 may include a plurality of input ports that are configured to receive image signals of the image sensors and an output port that is configured to output an image signal to the input receiver 172. In addition, selection may be a concept of an action including multiplexing image signals to be output from the output port and selected by the multiplexer 170 from the image signals received via the input ports.

The demosaicing processor 174 may be configured to generate image data for display based on the R image signal, the G image signal, and the B image signal input to the input receiver 172 in the first period. The demosaicing processor 174 may be an example of a first generation unit. The demosaicing processor 174 may perform demosaicing processing on the R image signal, the G image signal, and the B image signal to generate the image data for display. The demosaicing processor 174 may perform sparsification on the R image signal, the G image signal, and the B image signal. Thus, the R image signal, the G image signal, and the B image signal after the sparsification may be converted into image signals of Bayer array to generate the image data for display. The transmitter 190 may be configured to transmit the image data for display to a display device. the transmitter 190, for example, may transmit the image data for display to the remote operation device 300. The remote operation device 300 may be configured to display the image data for display as an image of a real-time scene at the display.

The record processor 178 may be configured to generate image data for recordation according to a predetermined recording format based on the R image signal, the G image signal, the B image signal, the RE image signal, and the NIR image signal input into the input receiver 172 in the second period. The record processor 178 may be an example of a second generation unit. The record processor 178 may generate RAW data that is used as the image data for recordation according to a RAW format from the R image signal, the G image signal, the B image signal, the RE image signal, and the NIR image signal. The record processor 178 may generate the all-pixel image data for recordation without performing the sparsification on the R image signal, the G image signal, the B image signal, the RE image signal, and the NIR image signal. The record processor 178 may be configured to store the image data for recordation in the storage device 192. The storage device 192 may be a computer-readable recording medium, which includes at least one of SRAM, DRAM, EPROM, EEPROM, or a USB storage device. the storage device 192 may be arranged inside a housing of the camera device 100. The storage device 192 may be detachably arranged at the housing of the camera device 100.

The multiplexer 170 may be configured to select and input at least one of the R image signal, the G image signal, or the B image signal into the input receiver 172 in the first period and discard remaining image signals together with the RE image signal and the NIR image signal. The demosaicing processor 174 may be configured to perform the sparsification only on the image signals input into the input receiver 172 in the first period to generate the image data for display.

The multiplexer 170 may be configured to select and input at least one of the R image signal, the G image signal, the B image signal, the RE image signal, or the NIR image signal into the input receiver 172 in the second period and discard the remaining image signals. The record processor 178 may be configured to generate the image data for recordation of the RAW format without performing the sparsification on the image signals input into the input receiver 172 in the second period.

Generating the image data for recordation by the record processor 178 may take a certain amount of time. Therefore, when the record processor 178 ends generating the image data for recordation, or before storing the image data for recordation in the storage device 192, the multiplexer may only select and input the R image signal, the G image signal, and the B image signal from the second period to the first period and start into the input receiver 172. The demosaicing processor 174 may not wait for the record processor 178 to generate and store the image data for recordation in the storage device 192. The demosaicing processor 174 may be configured to generate the image data for display in order according to the R image signal, the G image signal, and the B image signal input into the input receiver 172 in order in a next first period. Each time when the demosaicing processor 174 generates the image data for recordation, the image data for display may be transmitted to the display device such as the remote operation device 300. That is, when the record processor 178 generates the image data for recordation and stores the image data for recordation in the storage device 192, the image data captured by the camera device 100 may be displayed as the real-time scene at the display device such as the remote operation device 300.

A data amount of the image data for display may be less than a data amount of the image data for recordation. Thus, the processing load of the demosaicing processor 174 may be reduced.

The camera controller 180 further includes a receiver 184 and a switcher 188. The receiver 184 may be configured to receive a storage instruction for storing the image data for recordation in the storage device 12. The receiver 184 may be configured to receive the storage instruction from the user through an external terminal such as the remote operation device 300. When the camera device 100 is arranged at a predetermined position, the receiver 184 may receive the storage instruction from the UAV controller 30. When the UAV 10 has a predetermined position, the UAV controller may determine that the position of the camera device 100 is the predetermined position, and the receiver 184 may receive the storage instruction from the UAV controller 30. The camera device 100includes a GPS receiver. Thus, the camera controller 180 may determine whether the position of the camera device 100 is the predetermined position according to its position information from the GPS receiver.

The switcher 188 may perform switching between the first period and the second period. When the receiver 184 receives the storage instruction, the switcher 188 indicates that the multiplexer 170 is switched from the first period to the second period. Further, the switcher 188 may switch the image signal from the input receiver 172 from being input to the demosaicing processor 174 to being input to the record processor 178. When receiving a switch instruction, the multiplexer 170 may transit from the first period to the second period. That is, the multiplexer 170 may transit from the processing of selecting and inputting the R image signal, the G image signal, and the B image signal into the input receiver 172 and discarding the RE image signal and the NIR image signal to the processing of selecting and inputting the R image signal, the G image signal, the B image signal, the RE image signal, and the NIR image signal into the input receiver 172.

The switcher 188 may perform switching between the first period and the second period at a predetermined moment. The switcher 188 may perform switching between the first period and the second period at a predetermined cycle. When the receiver 184 receives a notice that the UAV 10 continuously performs hovering in a predetermined period of time, the switcher 188 may perform switching between the first period and the second period. When the UAV 10 continuously performs hovering in the predetermined period of time, the multiplexer 170 may transit from the processing of selecting and inputting the R image signal, the G image signal, and the B image signal into the input receiver 172 and discarding the RE image signal and the NIR image signal to the processing of selecting and inputting the R image signal, the G image signal, and the B image signal, the RE image signal, and the NIR image signal into the input receiver 172.

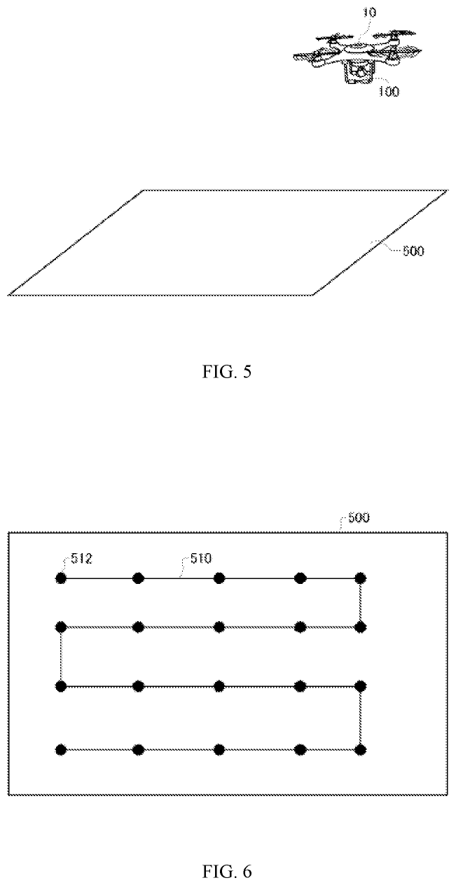

FIG. 5 is a schematic diagram showing a scene of photographing using the UAV 10, which carries the camera device 100, according to some embodiments of the present disclosure. While the UAV 10 flies over a photographing area 500 such as crops, the camera device 100 may capture and store multispectral images in the storage device 192 in order. The user may view an image of a real-time scene of the camera device 100 displayed on the display of the remote operation device 300 and determine the photographing area captured by the camera device 100 through vision. Moreover, the camera device 100 may be caused to store the multispectral images in the storage device 192 in order.

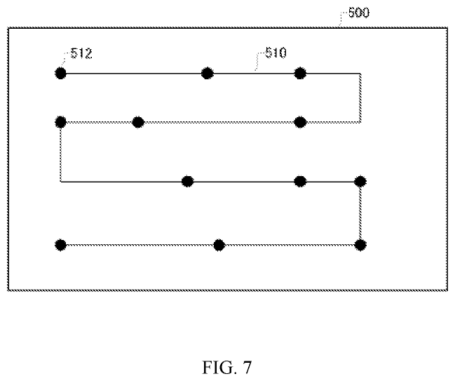

As shown in FIG. 6, a photographing area 500 is predetermined on a flight route 510 of the UAV 10. Locations, where the multispectral images are stored into the storage device 192, may include locations 512 at predetermined intervals on the flight route 510. As shown in FIG. 7, the location where the multispectral image is stored into the storage device 192 may be any location 512 on the flight route 510. For example, the user may refer to the real-time scene of the camera device 100 on the flight route 510 and register the location where the multispectral image is to be stored through the remote operation device 300.

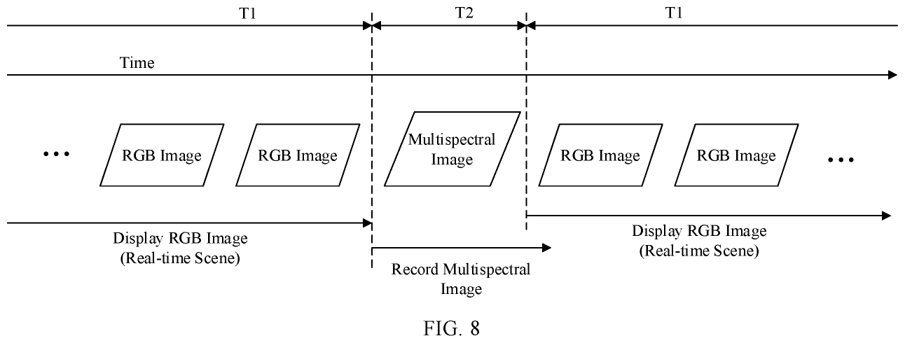

FIG. 8 is a schematic diagram showing an image of a time flow of processing contents in a camera controller 180 according to some embodiments of the present disclosure. In the first period T1, the multiplexer 170 may select and input the R image signal, the G image signal, and the B image signal into the input receiver 172 and discard the RE image signal and the NIR image signal. The demosaicing processor 174 may perform the sparsification on the R image signal, the G image signal, and the B image signal to generate RGB image data of Bayer arrays. The transmitter 190 may transmit the RGB image data to an external display device such as the remote operation device 300. The display device may display the RGB image data as an image of the real-time scene on the display.

In the second period T2, the multiplexer 170 may select and input the R image signal, the G image signal, the B image signal, the RE image signal, and the NIR image signal into the input receiver 172. The record processor 178 may generate the multispectral image as the image data for recordation according to a predetermined recording format such as the RAW format based on the R image signal, the G image signal, the B image signal, the RE image signal, and the NIR image signal. The record processor 178 may store the multispectral image in the storage device 192. Before the record processor 178 generates and stores the multispectral image in the storage device 192, the multiplexer 170 may switch from the second period T2 to the first period T1 and only select and input the R image signal, the G image signal, and the B image signal into the input receiver 172.

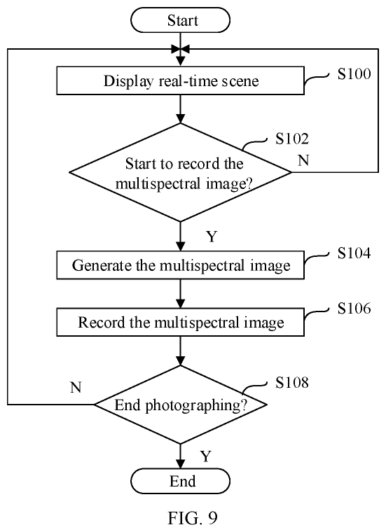

FIG. 9 is a schematic flowchart showing a processing process of the camera device 100 recording the multispectral image according to some embodiments of the present disclosure.

The UAV 10 starts to fly. The RGB image data transmitted from the camera device 100 is displayed as the image of the real-time scene on the display of the remote operation device (S100). The receiver 184 determines whether a recording instruction of the multispectral image is received through the remote operation device 300 (S102). When the receiver 184 receives the recording instruction, the multiplexer 170 selects and inputs the R image signal, the G image signal, the B image signal, the RE image signal, and the NIR image signal into the input receiver 172. The record processor 178 generates the multispectral image as the image data for recordation according to the predetermined recording format, such as the RAW format, based on the R image signal, the G image signal, the B image signal, the RE image signal, and the NIR image signal (S104). The record processor 178 stores the multispectral image into the storage device 192 (S106). If capturing the multispectral image is not ended (S108), the camera device 100 repeats the above processes.

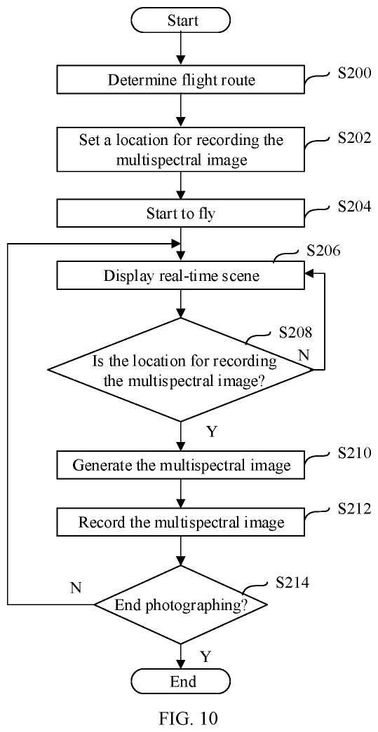

FIG. 10 is a schematic flowchart showing a processing process of the camera device 100 recording the multispectral image according to some embodiments of the present disclosure.

The user determines the flight route of the UAV 10 through the remote operation device 300 (S200). The user may determine the flight route from a map displayed at the remote operation device 300. The user may select the desired flight route from a plurality of predetermined flight routes. Based on an instruction from the user received by the remote operation device 300, the camera device 100 sets a location for recording the multispectral image on the flight route (S202). This location is also referred to as a “multispectral image recordation location.”

Then, the UAV 10 starts to fly along the flight route (S204). When the UAV 10 is not at the location of recording the multispectral image, the RGB image data transmitted from the camera device 100 is displayed as the image of the real-time scene on the display of the remote operation device 300 (S206). The receiver 184 determines whether the UAV 10 arrives at the location of recording the multispectral image (S208). When the receiver 184 responds to that the UAV 10 arrives at the location of recording the multispectral image and receives the recording instruction from the UAV controller 30, the receiver 184 may determine that the UAV 10 arrives at the location of recording the multispectral image.

When the receiver 184 receives the recording instruction, the multiplexer 170 may select and input the R image signal, the G image signal, the B image signal, the RE image signal, and the NIR image signal into the input receiver 172. The record processor 178 generates the multispectral image as the image data for recordation according to the predetermined recording format such as the RAW format based on the R image signal, the G image signal, the B image signal, the RE image signal, and the NIR image signal (S210). The record processor 178 stores the multispectral image into the storage device 192 (S212). If capturing the multispectral image is not ended (S214), the camera device 100 repeats the processes after process S204.

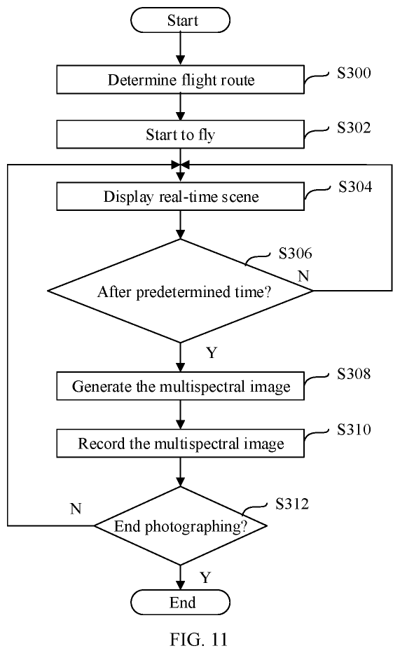

FIG. 11 is a schematic flowchart showing a processing process of the camera device 100 recording the multispectral image according to some embodiments of the present disclosure.

The user determines the flight route of the UAV 10 through the remote operation device 300 (S300). Then, the UAV 10 starts to fly along the flight route (S302). When the UAV 10 is not at the moment of recording the multispectral image (“multispectral image recordation moment”), the RGB image data transmitted from the camera device 100 is displayed as the image of the real-time scene on the display of the remote operation device 300 (S304). The receiver 184 determines whether the UAV 10 flies on the flight route for a predetermined time, or whether the predetermined time passes after the last recording of the multispectral image (S306). If the UAV 10 is at the moment of recording the multispectral image, the multiplexer 170 may select and input the R image signal, the G image signal, the B image signal, the RE image signal, and the NIR image signal into the input receiver 172. The record processor 178 generates the multispectral image as the image data for recordation according to the predetermined recording format such as the RAW format based on the R image signal, the G image signal, the B image signal, the RE image signal, and the NIR image signal (S308). The record processor 178 stores the multispectral image into the storage device 192 (S310). If capturing the multispectral image is not ended (S312), the camera device 100 repeats the processes after process S302.

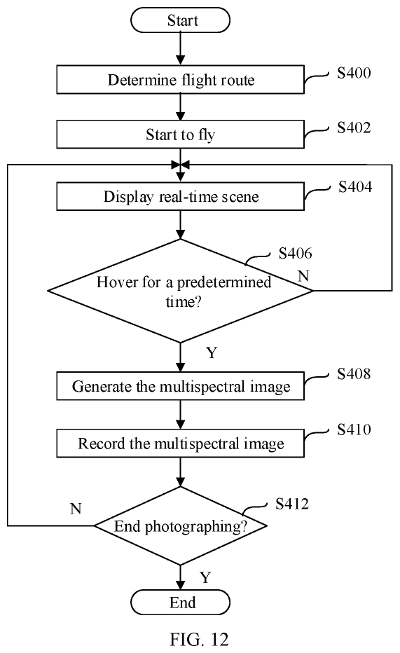

FIG. 12 is a schematic flowchart showing a processing process of the camera device 100 recording the multispectral image according to some embodiments of the present disclosure.

The User determines the flight route of the UAV 10 through the remote operation device 300 (S400). Then, the UAV 10 starts to fly along the flight route (S402). When the UAV 10 is not at the moment of recording the multispectral image, the RGB image data transmitted from the camera device 100 is displayed as the image of the real-time scene on the display of the remote operation device 300 (S404). The receiver 184 determines whether the UAV 10 has hovered for a predetermined period of time (S406). When a reception and recording instruction corresponding to the situation that the UAV 10 has hovered for the predetermined period of time is received from the UAV controller 30, the receiver 184 may determine that the UAV 10 hovers for the predetermined time.

If the UAV 10 has hovered for the predetermined period of time, the multiplexer 170 may select and input the R image signal, the G image signal, the B image signal, the RE image signal, and the NIR image signal into the input receiver 172. The record processor 178 generates the multispectral image as the image data for recordation according to the predetermined recording format such as the RAW format based on the R image signal, the G image signal, the B image signal, the RE image signal, and the NIR image signal (S408). The record processor 178 stores the multispectral image into the storage device 192 (S410). If capturing the multispectral image is not ended (S412), the camera device 100 repeats the processes after process S402.

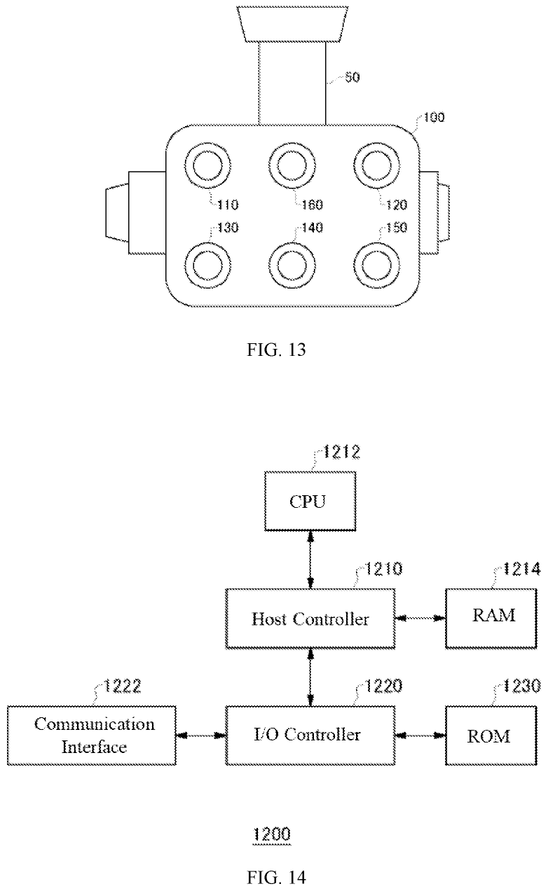

FIG. 13 is a schematic diagram showing an appearance of a camera device 100 that is carried by the UAV 10 according to some embodiments of the present disclosure. In addition to the G camera 120, the B camera 130, the RE camera 140, and the NIR camera 150, the camera device 100 further includes an RGB camera 160, which is different from the camera device 100 shown in FIG. 2. The RGB camera 160 may be same as a general camera and includes an optical system and an image sensor. The image sensor may include a filter that allows light with a wavelength band of the red range to pass through, a filter that allows light with a wavelength band of the green range to pass through, and a filter that allows light with a wavelength band of the blue range to pass through, which are arranged in Bayer arrays. The RGB camera 160 may output an RGB image. The wavelength band of the red range, for example, may range from 620 nm˜750 nm. The wavelength band of the green range, for example, may range from 500 nm˜570 nm. The wavelength band of the blue range, for example, may range from 450 nm˜500 nm.

The multiplexer 170 may select and input an RGB image signal from the RGB camera into the input receiver 172 in the first period. In the first period, the multiplexer 170 may discard the R image signal, the G image signal, the B image signal, the RE image signal, and the NIR image signal. The demosaicing processor 174 may generate RGB image data for display from the RGB image signal.

The multiplexer 170 may select and input the R image signal, the G image signal, the B image signal, the RE image signal, and the NIR image signal into the input receiver 172 and discard the RGB image signal in the second period. The multiplexer 170 may select and input the R image signal, the G image signal, the B image signal, the RE image signal, the NIR image signal, and the RGB image signal into the input receiver 172. The record processor 178 may generate the multispectral image as the image data for recordation according to the predetermined recording format such as the RAW format based on the R image signal, the G image signal, the B image signal, the RE image signal, the NIR image signal, and the RGB image signal.

According to above, the camera device 100 of embodiments of the present disclosure may efficiently record the multispectral image data and determine the contents photographed by the camera device 100 in real-time.

FIG. 14 shows an example of a computer 1200 that fully or partially shows various aspects of the present disclosure. Programs installed on the computer 1200 can cause the computer 1200 to function as an operation associated with a device or one or more units of the device according to embodiments of the present disclosure. In some embodiments, the program can cause the computer 1200 to implement the operation or one or more units. The program may cause the computer 1200 to implement a process or a stage of the process according to embodiments of the present disclosure. The program may be executed by a CPU 1212 to cause the computer 1200, e.g., the CPU 1212, to implement a specified operation associated with some or all blocks in the flowchart and block diagram described in the present specification.

In some embodiments, the computer 1200 includes the CPU 1212 and a RAM 1214. The CPU 1212 and the RAM 1214 are connected to each other through a host controller 1210. The computer 1200 further includes a communication interface 1222, and an I/O unit. The communication interface 1222 and the I/O unit are connected to the host controller 1210 through an I/O controller 1220. The computer 1200 further includes a ROM 1230. The CPU 1212 operates according to programs stored in the ROM 1230 and the RAM 1214 to control each of the units.

The communication interface 1222 communicates with other electronic devices through networks. A hardware driver may store the programs and data used by the CPU 1212 of the computer 1200. The ROM 1230 stores a boot program executed by the computer 1200 during operation, and/or the program dependent on the hardware of the computer 1200. The program is provided through a computer-readable storage medium such as CR-ROM, a USB storage drive, or IC card, or networks. The program is installed in the RAM 1214 or the ROM 1230, which can also be used as examples of the computer-readable storage medium, and is executed by the CPU 1212. Information processing described in the program is read by the computer 1200 to cause cooperation between the program and the above-mentioned various types of hardware resources. The computer 1200 implements information operations or processes to constitute the device or method.

For example, when the computer 1200 communicates with external devices, the CPU 1212 can execute a communication program loaded in the RAM 1214 and command the communication interface 1222 to process the communication based on the processes described in the communication program. The CPU 1212 controls the communication interface 1222 to read transmitting data in a transmitting buffer provided by a storage medium such as the RAM 1214 or the USB storage drive and transmit the read transmitting data to the networks, or write data received from the networks in a receiving buffer provided by the storage medium.

The CPU 1212 can cause the RAM 1214 to read all or needed portions of files or databases stored in an external storage medium such as a USB storage drive, and perform various types of processing to the data of the RAM 1214. Then, the CPU 1212 can write the processed data back to the external storage medium.

The CPU 1212 can store various types of information such as various types of programs, data, tables, and databases in the storage medium and process the information. For the data read from the RAM 1214, the CPU 1212 can perform the various types of processes described in the present disclosure, including various types of operations, information processing, condition judgment, conditional transfer, unconditional transfer, information retrieval/replacement, etc., specified by a command sequence of the program, and write the result back to the RAM 1214. In addition, the CPU 1212 can retrieve information in files, databases, etc., in the storage medium. For example, when the CPU 1212 stores a plurality of entries having attribute values of a first attribute associated with attribute values of a second attribute in the storage medium, the CPU 1212 can retrieve an attribute from the plurality of entries matching a condition specifying the attribute value of the first attribute, and read the attribute value of the second attribute stored in the entry. As such, the CPU 1212 obtains the attribute value of the second attribute associated with the first attribute that meets the predetermined condition.

The above-described programs or software modules may be stored on the computer 1200 or in the computer-readable storage medium near the computer 1200. The storage medium such as a hard disk drive or RAM provided in a server system connected to a dedicated communication network or Internet can be used as a computer-readable storage medium. Thus, the program can be provided to the computer 1200 through the networks.

An execution order of various processing such as actions, sequences, processes, and stages in the devices, systems, programs, and methods shown in the claims, the specifications, and the drawings, can be any order, unless otherwise specifically indicated by “before,” “in advance,” etc., and as long as an output of a previous processing is not used in a subsequent processing. Operation procedures in the claims, the specifications, and the drawings are described using “first,” “next,” etc., for convenience. However, it does not mean that the operation procedures must be implemented in this order.

The present disclosure is described above with reference to embodiments, but the technical scope of the present disclosure is not limited to the scope described in the above embodiments. For those of ordinary skill in the art, various changes or improvements can be made to the above-described embodiments. It is apparent from the claims that such changes or improvements are within the technical scope of the invention.

What is claimed is:

1. An image processing device comprising:
a processor; and
a storage device storing a program that, when executed by the processor, causes the processor to:
select a first image signal in a first period, the first image signal having a first wavelength band and being output by a first image sensor of a camera device;
select the first image signal and a second image signal in a second period, the second image signal having a second wavelength band and being output by a second image sensor of the camera device;
generate image data for display based on the first image signal selected in the first period; and
generate image data for recordation according to a predetermined recording format based on the first image signal and the second image signal selected in the second period.

2. The device of claim 1, wherein the program further causes the processor to:
transmit the image data for display to a display device.

3. The device of claim 1, wherein the program further causes the processor to, before generation or recordation of the image data for recordation ends:
transit from the second period to the first period; and
start to select the first image signal.

4. The device of claim 1, wherein a data amount of the image data for display is less than a data amount of the image data for recordation.

5. The device of claim 1, wherein the program further causes the processor to:
generate the image data for recordation in a RAW format.

6. The device of claim 1, wherein the program further causes the processor to:
select the first image signal, a third image signal, and a fourth image signal in the first period, the third image signal having a third wavelength band and being output by a third image sensor of the camera device, and the fourth image signal having a fourth wavelength band and being output by a fourth image sensor of the camera device;
select the first image signal, the second image signal, the third image signal, and the fourth image signal in the second period;
generate the image data for display based on the first image signal, the third image signal, and the fourth image signal selected in the first period; and
generate the image data for recordation based on the first image signal, the second image signal, the third image signal, and the fourth image signal selected in the second period.

7. The device of claim 1, wherein the program further causes the processor to:
select the first image signal, a third image signal, and a fourth image signal in the first period, the third image signal having a third wavelength band and being output by a third image sensor of the camera device, and the fourth image signal having a fourth wavelength band and being output by a fourth image sensor of the camera device;
select the first image signal, the second image signal, the third image signal, the fourth image signal, and a fifth image signal in the second period, the fifth image signal having a fifth wavelength band and being output by a fifth image sensor of the camera device;
generate the image data for display based on the first image signal, the third image signal, and the fourth image signal selected in the first period; and
generate the image data for recordation based on the first image signal, the second image signal, the third image signal, the fourth image signal, and the fifth image signal selected in the second period.

8. The device of claim 7, wherein:
the first wavelength band is in a red range;
the second wavelength band is at an edge of the red range;
the third wavelength band is in a green range;
the fourth wavelength band is in a blue range; and
the fifth wavelength band is in a near-infrared range.

9. The device of claim 1, wherein the program further causes the processor to:
select the first image signal in the first period;
select the first image signal, the second image signal, a third image signal, a fourth image signal, a fifth image signal, and a sixth image signal in the second period, the third image signal having a third wavelength band and being output by a third image sensor of the camera device, the fourth image signal having a fourth wavelength band and being output by a fourth image sensor of the camera device, the fifth image signal having a fifth wavelength band and being output by a fifth image sensor of the camera device, and the sixth image signal having a sixth wavelength band and being output by a sixth image sensor of the camera device;
generate the image data for display based on the first image signal selected in the first period; and
generate the image data for recordation based on the first image signal, the second image signal, the third image signal, the fourth image signal, the fifth image signal, and the sixth image signal selected in the second period.

10. The device of claim 9, wherein:
the first wavelength band is in a first red range, a first green range, and a first blue range;
the second wavelength band is at an edge of a red range;
the third wavelength band is in a near-infrared range;
the fourth wavelength band is in a second red range that is narrower than the first red range;
the fifth wavelength band is in a second green range that is narrower than the first green range; and
the sixth wavelength band is in a second blue range that is narrower than the first blue range.

11. The device of claim 1, wherein the program further causes the processor to:
receive a storage instruction for storing the image data for recordation in a storage device; and
in response to the storage instruction being received, transit from the first period to the second period.

12. The device of claim 1, wherein the program further causes the processor to:
in response to the camera device being in a predetermined location, transit from the first period to the second period.

13. The device of claim 1, wherein the program further causes the processor to:
perform switching between the first period and the second period at a predetermined moment.

14. A camera device comprising:
the image processing device according to claim 1;
the first image sensor; and
the second image sensor.

15. A mobile body, comprising:
a camera device including:
a first image sensor;
a second image sensor; and
an image processing device including:
a processor; and
a storage device storing a program that, when executed by the processor, causes the processor to:
select a first image signal in a first period, the first image signal having a first wavelength band and being output by the first image sensor of the camera device;
select the first image signal and a second image signal in a second period, the second image signal having a second wavelength band and being output by the second image sensor of the camera device;
generate image data for display based on the first image signal selected in the first period; and
generate image data for recordation according to a predetermined recording format based on the first image signal and the second image signal selected in the second period.

16. The mobile body of claim 15, wherein:
the mobile body is an aerial body; and
the program further causes the processor to:
in response to the aerial body continuously hovering for a predetermined period of time, switch from the first period to the second period.

17. The mobile body of claim 16, wherein the program further causes the processor to:
control the mobile body to move along a predetermined route.

18. An image processing method comprising:
selecting a first image signal in a first period, the first image signal having a first wavelength band and being output by a first image sensor of a camera device;
selecting the first image signal and a second image signal in a second period, the second image signal having a second wavelength band and being output by a second image sensor of the camera device;
generating image data for display based on the first image signal selected in the first period; and
generating image data for recordation according to a predetermined recording format based on the first image signal and the second image signal selected in the second period.

19. The method of claim 18, further comprising:
transmitting the image data for display to a display device.

20. The method of claim 18, further comprising, before generation or recordation of the image data for recordation is ended:
transiting from the second period to the first period; and
starting to select the first image signal.
